(19) United States
(12) Patent Application Publication
(10) Pub. No.: US 2010/0046896 A1
(43) Pub. Date: Feb. 25, 2010

(54) LIQUID CRYSTAL POLYMER BLENDS FOR USE AS BUFFER FOR OPTICAL FIBER

(76) Inventors: Amaresh Mahapatra, Acton, MA (US); Stephen M. O'riorden, Stow, MA (US)

Correspondence Address: FRANCIS J. CAUFIELD, 6 APOLLO CIRCLE, LEXINGTON, MA, 02421-7025, US

(21) Appl. No.: 12/538,183

(22) Filed: Aug. 10, 2009

Related U.S. Application Data
(60) Provisional application No. 61/090,273, filed on Aug. 20, 2008.

(51) Int. Cl. G02B 6/44

(52) U.S. Cl. 385/114; 385/100

(57) ABSTRACT

This invention relates to the use of liquid crystal (LCP) blends for use as buffer layers in optical fiber cables to enhance strength and flexibility so as to meet the demanding requirements imposed on such cables for use in aircraft and the like. The inventive optical fiber cable comprises one or more optical fibers having a core having a given index of refraction and a cladding layer surrounding the core and having an index of refraction lower than that of the core so that the two in combination are capable of propagating light along the length of the fiber cable. At least one exterior buffer layer surrounds the cladding, the exterior buffer layer comprising a liquid crystal polymer and thermoplastic blended coating formed as a layer around the cladding, preferably by cross-head extrusion. The thermoplastic has properties such that the blended coating has a strain at break larger than the liquid crystal polymer would otherwise have acting alone. The thermoplastic comprises a fluoropolymer, and the blended coating includes a compatibilizer so that the blended coating is a reactive blend.

### CROSS REFERENCE TO RELATED APPLICATION

This application claims the benefit of priority from U.S. Provisional Application No. 61/090,273 filed on Aug. 20, 2008 with the title LIQUID CRYSTAL POLYMER BLENDS FOR USE AS BUFFER FOR OPTICAL FIBER, the entire contents of which are incorporated herein by reference.

### FIELD OF THE INVENTION

This invention generally relates to the use of a new class of materials, and more particularly, to the use of liquid crystal polymer (LCP) blends as extruded optical fiber buffer layers.

### BACKGROUND OF THE INVENTION

LCP resins are commercially available from several major suppliers—Ticona, Allied Chemicals, Dupont and Sumitomo. Suitable blends consisting of LCPs and other thermoplastics such as fluoropolymers have the strength, barrier properties, and low cold creep of LCPs and the flexibility of fluoropolymers to enable a strong yet flexible optical cable. LCP blends can be designed to have the following advantages: high strength, high flexibility and kink resistance; no thermal degradation up to 400° C.; no cold creep; extremely low moisture absorption and transmission; excellent chemical stability.

Optical fibers are extensively used in military aircraft, both as interconnects in electronic cards and in aircraft frames. Fiber ribbons, manufactured primarily by W.L. Gore, used in computer cards suffer significant breakage failures, usually close to the exit point from the MT connectors and at points where they have been tacked to prevent movement. Fiber cables, primarily manufactured by OFS, suffer “maintenance induced breaks” when, for example, a heavy object falls on them, or they are bent sharply at an anchor point. Both these situations would benefit from development of a rugged, durable optical replacement fiber. Ideally, it should be a drop-in replacement for currently used fiber.

Optical fiber consists of a silica core and cladding surrounded by plastic buffer material. Optical ribbon cable, manufactured by W.L. Gore, uses from 2 to 12 optical fibers which have a buffer of acrylate and silicon with combined 250 μm OD. The fibers are held together with a surrounding wrap of foamed or expanded PTFE (U.S. Pat. No. 5,675,686A1, 1997). The 12 fiber ribbon cable is 0.016″ thick and 0.130″ wide with a fiber center-to-center spacing of 250 μm (See FIG. 1). The 100% fluoropolymer outer jacket prevents degradation due to chemicals and common solvents. However, Gore's expanded PTFE buffering system is 70% air and results in a very flexible fiber but with little mechanical strength.

The Joint Strike Fighter Program (F-35), requires the design and manufacture of rack mounted signal processing boards for the mission computer that contain fiber ribbon coupled optical transceivers. They primarily use optical ribbon cable manufactured by W.L. gore as described above. The transceivers have four input and four output optical ports that are pigtailed to the fiber ribbon. The other end of the ribbon exits a box through a panel mounted MT connector. The ribbon cable manufactured by W.L. Gore, has an average run length of 12″.

Manufacturers have experienced several serious problems in the assembly of the transceiver boards. Epoxy used at the fiber to ferrule insertion point wicks and hardens along the buffer and makes that section brittle. During installation of the transceiver on the board, the ribbon is held aside by being taped away from the transceiver pin area while the transceiver is hand soldered in place. There is a lot of handling, and the brittle, epoxy coated exit point of the fiber often breaks or suffers cracks that later become failure points.

After the transceiver has been bonded in place, the ribbon fiber is held steady within the enclosure by an epoxy bead at some convenient point. Subsequent troubleshooting requires that the epoxy bead be pried off, often breaking the pigtail. Once the fiber pigtail breaks, the whole unit has to be scrapped even though optical transceivers cost several thousands of dollars. The board has to be pulled, heated up to solder temperature and a new transceiver installed, all of which results in large expenditures of time and money.

Clearly this application would benefit from development of a ribbon cable that was flexible enough to be routed within the limited dimensions of a computer board yet strong enough to survive any accidental snagging during installation or repair.

OFS, General Cable and Tensolite manufacture optical cables used in aircraft frames, such as JSF, F-22 and F-18. The most popular brand of optical cable is manufactured by OFS under the trade name FlightGuide. The optical fiber used consists of 125 μm silica (core plus cladding) surrounded by a thin layer of pyrolytic carbon for hermeticity (U.S. Pat. No. 4,183,621 A1, 1980), followed by a dual buffer layer of silicone and ETFE for a final OD of 450 μm. Cable is constructed from this basic optical fiber by applying a wrap of braided aramid yarn with an outer jacket of ETFE for a final cable diameter of 1.8 mm (See FIG. 2).

Sometimes the cable fails due to “maintenance induced breaks” such as those suffered if a heavy object falls on the cable, or a door is slammed on it. This is not because the braided aramid yarn tears, but because the structure underneath (marked “Basic fiber” in FIG. 2) is not sufficiently kink resistant. Indeed, there is anecdotal evidence that the plasma application of pyrolytic carbon to the silica surface for hermeticity, fundamentally weakens the silica material making it more susceptible to breakage.

Therefore, there is a need for optical cable for aircraft frames that is stronger and less bend and kink sensitive than the currently used pyrolytic carbon/silicone/polyimide buffered fiber and it is a primary object of the present invention to provide such a cable.

This new optical cable should also meet the following specifications:
Operating Temp −40° C. to +125° C. (required for aircraft frame applications)
Storage Temp −55° C. to +165° C. (upper limit required for aircraft frame applications)

Accordingly, it is a further object of this invention to meet the foregoing operating and storage temperature requirements for an optical fiber for use with aircraft frames.

Other objects of the invention will, in part, appear hereinafter and will, in part, be obvious when the following detailed description is read in connection with the drawings.

### SUMMARY OF THE INVENTION

This invention relates to the use of liquid crystal (LCP) blends for use as buffer layers in optical fiber cables to enhance strength and flexibility so as to meet the demanding requirements imposed on such cables for use in aircraft and the like.

The inventive optical fiber cable comprises one or more optical fibers having a core having a given index of refraction and a cladding layer surrounding the core and having an index of refraction lower than that of the core so that the two in combination are capable of propagating light along the length of the fiber cable.

At-least one exterior buffer layer surrounds the cladding, the exterior buffer layer comprising a liquid crystal polymer and thermoplastic blended coating formed as a layer around the cladding, preferably by cross-head extrusion. The thermoplastic has properties such that the blended coating has a strain at break larger than the liquid crystal polymer would otherwise have acting alone. The thermoplastic comprises a fluoropolymer, and the blended coating includes a compatibilizer so that the blended coating is a reactive blend.

In another aspect, the thermoplastic comprises a fluoropolymer, and the blended coating includes a compatibilizer so that the blended coating is a reactive blend.

In yet another aspect, the optical fiber cable further includes an abrasion layer formed over the exterior buffer layer to increase abrasion resistance.

### BRIEF DESCRIPTION OF THE DRAWINGS

The structure, operation, and methodology of the invention, together with other objects and advantages thereof, may best be understood by reading the detailed description in connection with the drawings in which each part has an assigned a label and/or numeral that identifies it wherever it appears throughout the various drawings and wherein:

FIG. 1 is a diagrammatic elevational view of a prior art twelve ribbon fiber manufactured by W. L. Gore;

FIG. 2 is a diagrammatic perspective view showing the construction of a prior art OFS FlightGuide Aerospace cable with a hermetic coating of pyrolitic carbon and a coating of polyimide;

FIG. 3 is a diagrammatic elevational view of a ribbon fiber constructed in accordance with the invention showing an extruded blended liquid crystal polymer (LCP) buffer on commercially available ribbon fiber;

FIG. 4 is a graph showing a typical stress versus strain curve for 30 mil ID Vectra A950 LCP material;

FIG. 5 is a diagrammatic elevational view of a cable of diameter “d” bent through a 180° arc of inner radius “r”;

FIG. 6 is a graph showing the tensile properties for TLCP/LDPE/compatibilizer blends as a function of the screw speeds used to prepare the blends;

FIG. 7 is a graph showing the tensile properties for TLCP/LDPE/compatibilizer blends as a function of the extruder temperature used to prepare the blends;

FIGS. 8a and 8b are graphs showing, respectively, DSC heating thermograms and DSC cooling thermograms for different mixing times at 300° C.;

FIG. 9 is a graph showing the storage modulus (E′) as a function of temperature for PTFE/LCP blend; and

FIG. 10 is a graph showing the effect of LCP concentration on modulus of LCP/PFA sheets with draw down ratio of 10.

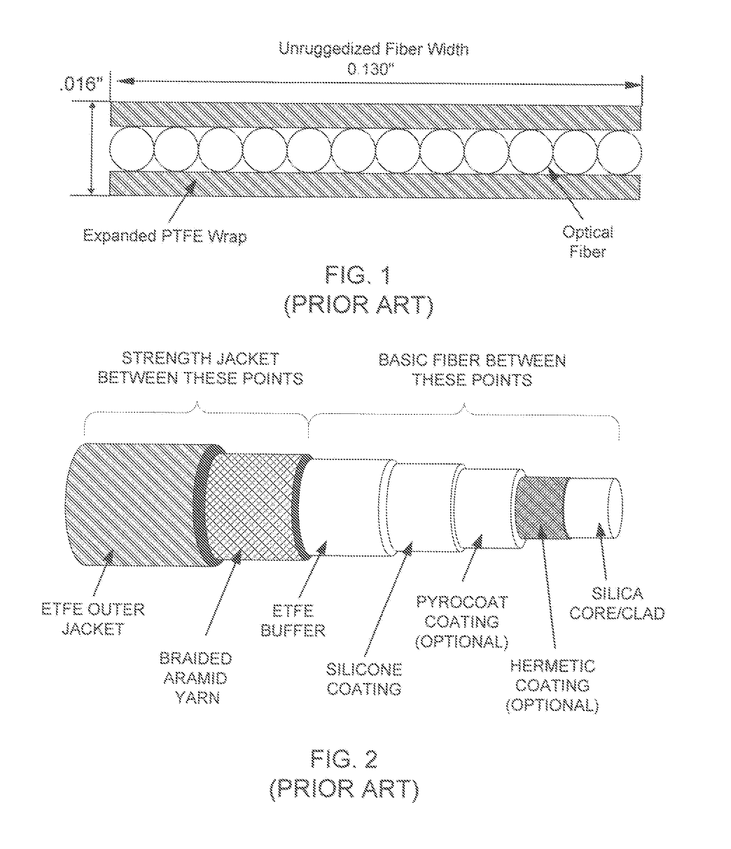

### DETAILED DESCRIPTION

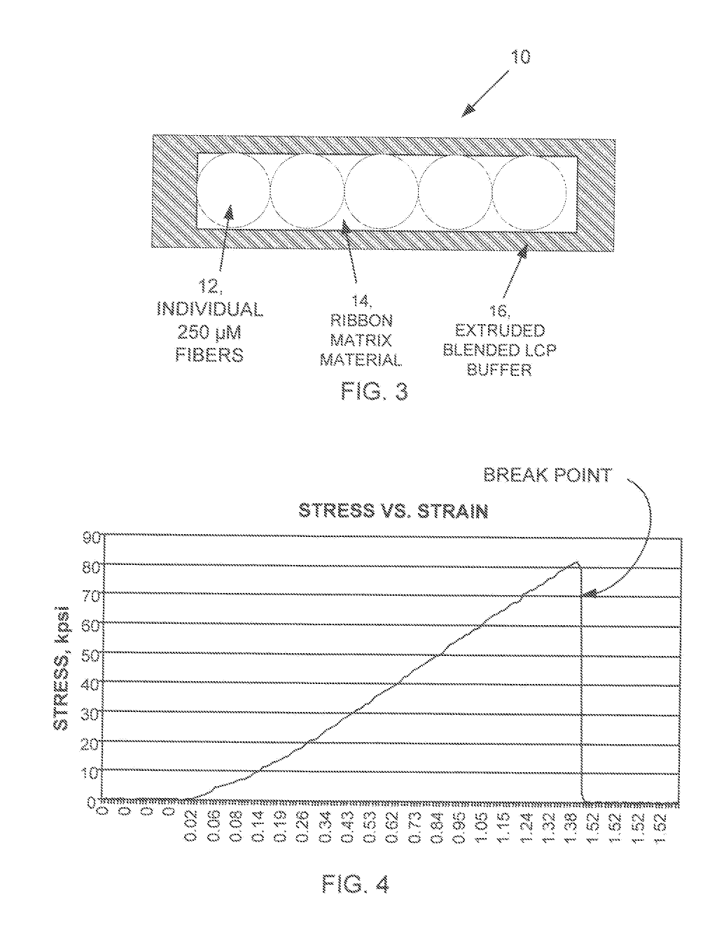

This invention relates to the fabrication of a ribbon cable that consists of extruding blended LCP buffer material on top of commercially available ribbon fiber as shown in FIG. 3 where the ribbon cable is designated generally at 10. As seen, ribbon cable 10 comprises one or more individual optical fibers 12 held in place by a ribbon matrix material 14, and surrounded in turn by a blended LCP buffer 16 that is preferably extruded around the ribbon matrix material 14 and optical fibers 12. The optical fibers 12 may be of any suitable size such as 250μ.

Also, disclosed is an optical cable consisting of silica surrounded by an extruded buffer layer of blended LCP. The LCP blend may either be extruded on silica fiber as it is drawn from perform or be applied to commercially available fiber with acrylate buffer or on reduced diameter, bend insensitive, fiber also available commercially from OFS, DRAKA, Corning and Sumitomo. The last two options are attractive since they would take commercially available fiber and make it kink and bend insensitive, moisture resistance, chemical resistant and increase tensile strength. The components of the blend are chosen so as to increase the strain at break while at the same time retaining sufficiently the desirable tensile and high temperature properties of LCPs. By suitable choice of blend, the fiber is strong yet flexible and kink resistant. This basic fiber would be used as a building block for ribbon or optical cables as described in detail in the following sections.

Liquid crystal polymers (LCPs) are a new class of materials ideally suited for use as extruded wire harness insulation and optical fiber buffers. LCP resins are commercially available from several major suppliers—Ticona, Allied Chemicals, Dupont and Sumitomo. LCPs have the following advantages:
a. No thermal degradation up to 450° C.; will meet 260° C, temperature rating (Jin, X., and T. S. Chung, 1999. “Thermal Decomposition Behavior of Main-Chain Thermotropic Liquid Crystal Polymers, Vectra A-950, B-950, and Xydar SRT-900.” Journal of Applied Polymer Science, V73, Issue 11, pp. 2195-2207).
b. Extremely low moisture absorption and transmission. No hydrolysis problem even at elevated temperatures.
c. Excellent chemical stability—no effect of immersion for prolonged periods in organic solvents, sulfuric acid, chromic acid, aviation fuels.
d. Tensile strength comparable to Kevlar.
e. LCP can be extruded on optical fibers using conventional screw type extruders, and, therefore, cost much less than tape construction.

The tensile properties of extruded tubes of A950 Vectra grade LCP with an OD and ID of 0.03″ and 0.01″, respectively, have been measured. A typical stress vs. strain curve is shown in FIG. 4. Note that the curve is fairly linear, the stress at break and strain at break are 80 kpsi and 1.5%, respectively. This corresponds to a tensile modulus of 5333 kpsi or 36 Gpa, which compares favorably with the tensile modulus of a hard ceramic like silica, which has a modulus of 70 GPa.

Table 1 compares the tensile strength (which is the same as stress at break) and strain at break for some thermoplastics that are used in wiring insulation compared vs. LCP. Vectra A950 LCP has the highest tensile strength, which is a desirable property for insulating materials. However, the strain at break is smaller, which may result in lack of flexibility.

TABLE 1
Comparison of tensile strength and strain
at break for some thermoplastics

| | Tensile | | |
|---|---|---|---|
| | Strength | Strain at | Melting Point |
| Thermoplastic | (MPa) | break (%) | (° C.) |
| Vectra A950 LCP | 547 | 2 | 280 |
| PFA | 29 | 300 | 360-240 |
| (Perfluoroalkoxyethylene) | | | |
| FEP (Fluorinated | 14 | 150 | 360-240 |
| Ethylene Propylene) | | | |
| Kapton | 221 | 80 | NA |
| (Thermoset, Polyimide) | | | |
| ETFE (Melt processible | 41 | 300 | 255-280 |
| fluoropolymer | | | |

A cable buffer material that combines the tensile strength of LCP with the flexibility of fluoropolymers would be very desirable. This would result in a flexible buffer material with increased tensile strength, and improved thermal and barrier properties. We have found concepts for blending LCPs with other thermoplastics to achieve precisely this outcome.

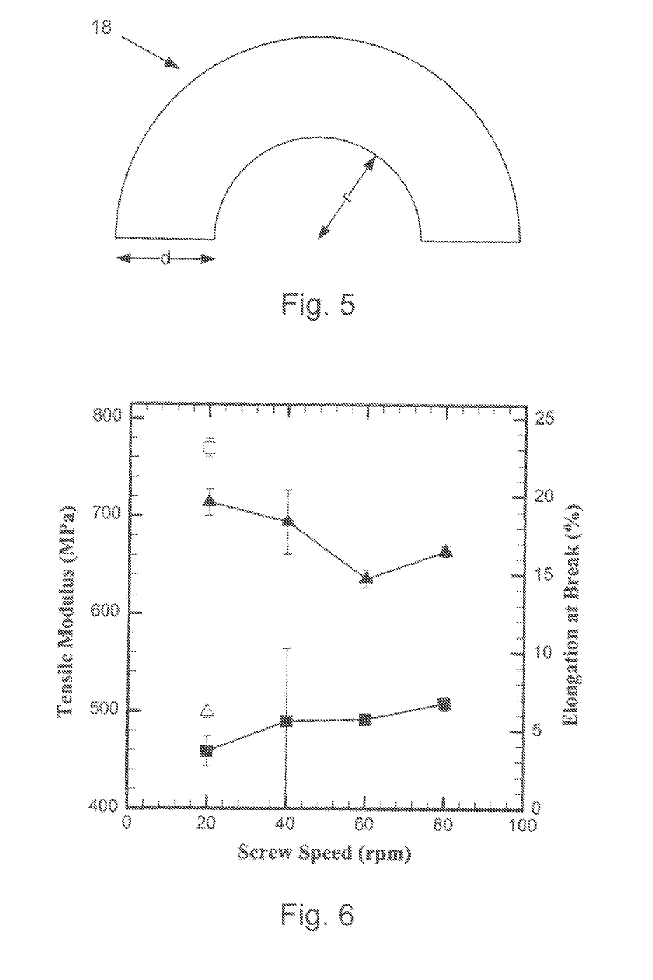

A simple way to estimate the strain produced when a cable is bent in an arc of a specific radius is shown in FIG. 5. Assume that the longitudinal center of a cable 18 is unstrained thus placing the outer edge under tensile strain while the inner edge is under compressive strain.

$$Length difference between inner and outer edge = π d$$

$$\begin{matrix}Differential strain between inner and outer edge = π d / π ( r + d / 2 ) \\ = 2 d / ( 2 r + d )\end{matrix}$$

If the cable is bent through a diameter six times the diameter of the cable (r=3d) the maximum strain is 30% which must be less than the breaking strain of the buffer.

Blending two different LCPs, one with a high melting temperature and the other with a low melting temperature has been used to achieve a blend with good molding properties and processability at low temperatures (Japanese Patent JP2007119639). LCPs and thermoplastics have been blended to achieve tensile strength and flexural strength greater than the corresponding properties of the constituent polymers (U.S. Pat. No. 6,221,962). Electrically conducting blends of LCP have also been proposed (U.S. Pat. No. 5,391,622).

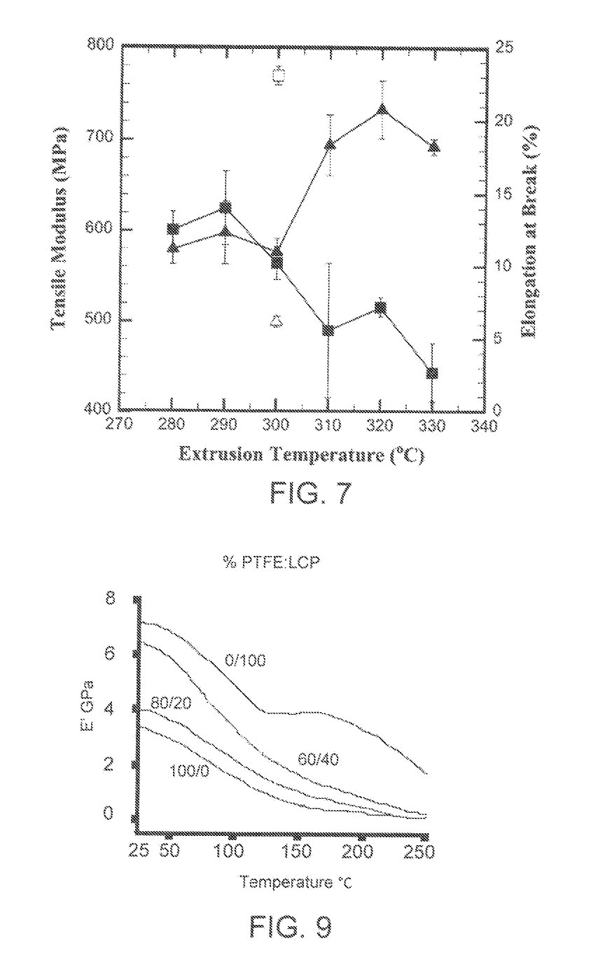

The effect of blending on breaking strain and tensile strength of the LCP is critical (Son, Y. and Weiss, R. A., 2001. “Compatibilizers for Thermotropic Liquid Crystal Polymer/Polyolefin Blends Prepared by Reactive Mixing: The Effects of Processing Conditions.” Polymer Engineering and Science, February 2001, V41, #2, pp. 329-340) have reported the results of reactively blending Vectra A950 LCP with low density polyethylene (LDPE). Reactive blends use compatibilizers which are polymeric additives that, when added to a blend of immiscible polymers, modifies their interfaces and stabilizes the blend. The compatibilizer may chemically graft to one or both components of the blend and alter their surface interactions favorably. Son, et al used a partially neutralized sodium salt of poly(ethylene-co-ran-acrylic) acid as a compatibilizer. FIGS. 6 and 7 show enhanced elongation at break for blends of Vectra A LCP and LDPE (Son, 2001). A single screw extruder is used for blending—extrusion temperature and screw speed are varied to control properties.

In FIG. 6, the screw speed at which the blend is extruded is varied while the compatibilizer preparation temperature is kept fixed at 310° C.

In FIG. 7, the preparation temperature of the compatibilizer is varied while the screw speed is kept fixed at 40 rpm. These figures have discrete points marked by unfilled symbols that indicate modulus and strain at break values of un-compatibilized blends. By suitable choice of extrusion conditions the elongation at break can be increased to 20% for compatibilized blend.

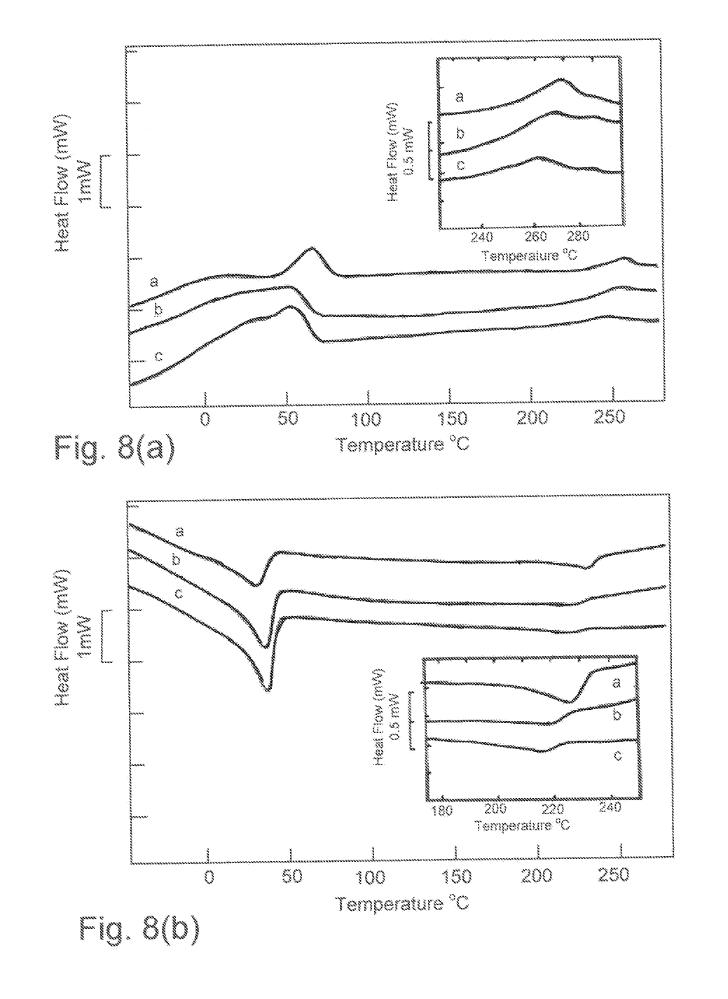

Another key issue is the effect of blending on the melting temperature of the LCP. FIG. 8a shows Differential Scanning Calorimetry (DSC) curves for a reactive blend of Vectra A LCP, with a melting temperature of 277° C., and a ethylene-co-acrylic acid ionomer compatibilizer (Zhang, H., R. A. Weiss, J. E. Kuder, and D. Cangiano, 2000. “Reactive Compatibilization of Blends Containing Liquid Crystalline Polymer.” Polymer, V41, pp. 3079-3082.). Blends of the ionomers were prepared by melt mixing in a Brabender mixer at 300° C. The extent of grafting of monomer to LCP was changed by changing mixing time between 1 to 10 min.

DSC curves for a 50/50% blend of Vectra A and monomer are shown in FIG. 8b. Both heating and cooling curves show phase transitions at about 70° C. and 270° C. which are the melting points of the compatibilizer and LCP, respectively. Melting temperature of the LCP decreases only from 268° C. to 260° C. as mixing time increases from 3 to 10 min. Therefore, LCP blends can be developed that do not degrade the desirable high temperature properties of LCPs.

The blending of Vectra C950 LCP from Ticona and PTFE is discussed in the literature (Das, T., A. K. Banthia, and B. Adjikari, 2006. “Binary Blends of Polytetrafluoroethylene and Liquid Crystalline Polymer.” Polymer-Plastics Technology and Engineering, V45, p. 1047). The goal was to enhance the mechanical properties of the PTFE by addition of small amounts of LCP using a physical blend without use of compatibilizer. The melting temperature of the LCP and PTFE was 325° C. and 327° C., respectively. The blend was prepared at 350° C. in a co-rotating twin-motor internal mixer with a rotor speed of 80 rpm. Residence time in the mixing chamber was 3-5 min. The viscosity of the blend decreased with increasing loading of LCP up to 20% LCP load.

The most relevant data from this paper relates to the storage modulus of the blends as a function of LCP load. Note that the storage modulus, E′, is the real part of the elastic modulus as measured by Dynamic Mechanical Analysis (DMA). FIG. 9 shows E′ as a function of temperature for PTFE/LCP blends with different loads of LCP. If we consider only the values at 25° C., the pure LCP and PTFE have E′ of 7.1 and 3.3 GPa, respectively. For a linear variation in E′, we would expect the 20% LCP loaded blend to have E′ of 4.1 GPa which is very close to the experimental value in FIG. 9.

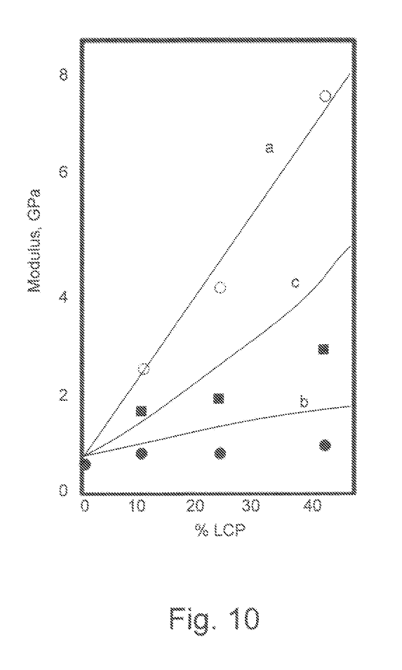

Blending experiments with Vectra C950 LCP and pefluoroalkylvinyl (PFA) with melting temperature of 305° C., have also been conducted. (Dutta, 1993). Modulus vs % LCP is shown in FIG. 10. With no LCP the fluoropolymer (PFA) modulus is about 0.7 GPa in both longitudinal and transverse directions. This is to be expected since PFA is not crystalline and does not exhibit anisotropic properties. As the % of LCP increases the anisotropy, as exhibited by difference in longitudinal and transverse modulus, increases. At 40% LCP these two moduli are 8 and 1 GPa respectively.

An optical cable may be protected from the environment by a plurality of buffers. Generally, a “tight tube” is the least expensive, but provides the least isolation from external stresses. A “loose tube buffer”, where one of the buffers is not mechanically attached to the structure underneath but can slide a little bit, is least sensitive to external stresses, particularly due to mismatch of coefficient of thermal expansion between buffer and structure underneath. The space between loose buffer and structure underneath is typically filled with a soft material. This construction gives good isolation from external stresses, but is expensive and difficult to terminate.

OFS uses expanded polytetrafluoroethylene (ePTFE) as a buffer for fibers because its porous composition simulates a “loose tube buffer” (U.S. Pat. No. 5675686A1, 1997). We have found from experience that an extruded LCP buffer also acts like a “loose tube” buffer. Since LCP is chemically inert it does not adhere to most materials even at elevated temperatures. We have made a standard strong tether fiber optic cable for Naval Undersea Warfare Center, Newport, R.I., by extruding LCP on standard acrylate buffered fiber. No special attempt is made to make the construction “loose tube”. However, the acrylate fiber can be pulled out of the LCP jacket fairly easily. The fiber can then be reinserted into the LCP jacket over a length of 5 meters. The coefficient of friction of LCP is extremely small and the fiber does not catch against the walls of the tube. Thus, LCP buffer has the inherent advantage of simulating a low cost. “loose tube” buffer.

A desirable buffer material consists of a single extruded layer of LCP/fluoropolymer reactive blend, where a compatibilizer has been used to induce some degree of chemical bonding between the LCP and fluoropolymer components. However, note that the blend may not be reactive but a physical blend of LCP and fluoropolymer with no compatibilizer and still have desirable properties (Das, T., et. al., 2006. “Binary Blends of Polytetrafluoroethylene and Liquid Crystal Polymer.” Polymer-Plastics Technology and Engineering, V45, pp. 1047-1052; Dutta, D., R. A. Weiss, and K. Kristal, 1993. “Liquid Crystalline Polymer/Fluoropolymer Blends: Preparation and Properties of Unidirectional Prepregs and Composite Laminates.” Polymer Engineering and Science, V33. No. 12, June, p. 838). Typically, the strain at break of the blended polymer is somewhere between the breaking strains of the two constituents. The exact proportion of the two constituents in the blend is chosen so as to optimize strength and flexibility.

The specific fluoropolymer resin for blending may be chosen from those listed in Table 2 below; namely, Perfluoroalkoxyethylene (PFA), Fluorinated Ethylene Propylene (FEP), and Ethylene tetrafluoroethylene (ETFE). They are desirable because they are extrudable so that the blend is also extrudable, and also because their strain at break is very large so that the blended material has a strain at break of higher than 5%.

TABLE 2
Melting temperatures of some candidate abrasion resistant
thermoplastics

| Thermoplastic | Melting Temperature (° C.) |
|---|---|
| FEP (Fluorinated Ethylene Propylene) | 260 |
| Tefzel ™ (modified ethylene- | 267 |
| tetrafluoroethylene) | |
| PFA (Perfluoroalkoxyethylene) | 360-420 (grade dependant) |

One problem encountered with some extruded LCPs is poor resistance to abrasion since the LCP layer tends to separate into fibers when abraded. For LCP buffered optical cables, we have increased abrasion resistance by extruding a thin layer of a thermoplastic, such as Nylon, over the LCP layer. It is possible that blended LCPs may not suffer from the abrasion seen in unblended LCP buffers. However, if this is not the case, for this invention, abrasion resistance can be increased by use of a secondary extruded thermoplastic layer. Although nylon can be used, as described above, nylon is a low temperature thermoplastic. To fabricate high temperature optical cables thermoplastics such as FEP (Fluorinated Ethylene Propylene), Tefzel™ (modified ethylenetetrafluoroethylene) and PFA (Perfluoroalkoxyethylene) may be used for the anti-abrasion layer (Table 2).

Extrusion may be achieved, for example, by the use of well-known cross-head extruders commonly in use in the plastics industry.

While fundamental and novel features of the invention have been shown and described with respect to preferred embodiments, it will be understood that those skilled in the art may make various changes to the described embodiments based on the teachings of the invention and such changes are intended to be within the scope of the invention as claimed.

What is claimed is:

1. An optical fiber cable comprising:
a core having a given index of refraction;
a cladding layer surrounding said core and having an index of refraction lower than that of said core so that the two in combination are capable of propagating light along the length of said fiber cable; and
at least one exterior buffer layer surrounding said cladding, said exterior buffer layer comprising a liquid crystal polymer and thermoplastic blended coating formed as a layer around said cladding, said thermoplastic having properties such that said blended coating has a strain at break larger than said liquid crystal polymer would have acting alone.

2. The optical fiber cable of claim 1 wherein said thermoplastic comprises a fluoropolymer.

3. The optical fiber cable of claim 1 wherein said blended coating includes a compatibilizer so that said blended coating is a reactive blend.

4. The optical fiber cable 1 where said thermoplastic comprises a fluoropolymer and said blended coating includes a compatibilizer so that said blended coating is a reactive blend.

5. The optical fiber cable of claim 1 further including an abrasion layer formed over the exterior buffer layer to increase abrasion resistance.

6. The optical fiber cable of claim 1 wherein said exterior buffer layer is extruded.
